(19) United States
(12) Patent Application Publication
(10) Pub. No.: US 2006/0129463 A1
(43) Pub. Date: Jun. 15, 2006

(54) Method and system for automatic product searching, and use thereof

(76) Inventor: Amir Shlomo Zicherman, Woodmere, NY (US)

Correspondence Address: BAY AREA INTELLECTUAL PROPERTY GROUP, LLC, PO BOX 210459, SAN FRANCISCO, CA, 94121-0459, US

(21) Appl. No.: 11/012,765

(22) Filed: Dec. 15, 2004

(51) Int. Cl. G06Q 30/00

(52) U.S. Cl. 705/26

(57) ABSTRACT

A client application monitors web pages visited by a consumer and determines if the visited web page is product oriented and, if so, then contacts a product server to automatically retrieve and display corresponding product purchasing information if available in product centric database. However, if the web page is not found in the database, it and its product information is added thereto. The database is created by a product information gathering web crawler and a second web product price crawler using the harvested product information to find prices corresponding to the product on unvisited web pages.

### FIELD OF THE INVENTION

The present invention relates generally to Internet price comparison solutions. More particularly, the invention relates to price comparison systems that may be seamlessly integrated with a web browser and are capable of obtaining price comparison information by automatically crawling web pages for product and pricing information, and by manual submission of such information into a server-side database.

### BACKGROUND OF THE INVENTION

Currently the web is a very efficient tool for searching for product ideas and information. If a user was looking to buy a new bicycle, for example, he or she could use search engine websites and other similar resources to find a wide diversity of bicycles models that satisfy certain desired specifications. After identifying the desired product(s), the next step is to find where to make the purchase on acceptable terms. Typically, consumers seek to purchase products from the least expensive vendor that is the most reliable. Several conventional web-based solutions exist that help a user to do a vendor comparison prior to buying a product. Well-known solutions are product price comparison websites such as cnet.com, pricegrabber.com, pricewatch.com, and mysimon.com, just to name a few. Such websites enable the user to compare prices for many specific products and vendors selling them. Although they have proven to be useful to a certain extent, they have a significant limitation despite their information being specific and well organized; that is, the number of vendors searched is very limited, as such sites typically only contain member vendors that have actively submitted their product prices into the product price comparison engine's databases, or that have some sort of symbiotic relationship therewith that allows products of member vendor to automatically be listed for price comparison. Moreover, users must be adept at keyword searching through the price comparison systems, in order to find the specific product they are looking to get a price comparison on.

To expand the number of vendors searched, websites such as Froogle.com implement a price comparison search engine that not only relies on price submissions from member vendors, but also crawls the Internet for web pages that list products for sale. Thus, a wider variety of vendors than the vendor-limited approaches may be searched. However, from the consumer's point of view, the problem of an optimal purchasing system is only partly solved. That is, Froogle.com only indexes the product pages that it is capable of finding, but is not fully aware of what the actual products on the web pages it indexes are. As such, Froogle.com cannot always group web pages showing the same product. By only partially grouping vendor's pages by product, a user is burdened by the need to know how to best search for a specific product of interest to get a good price comparison. This burden often translates to a user receiving specific results for a specific search, but if the search is too broad, an overwhelming number of undesired products will turn up in the search results, and make it very inefficient, if not impractical, to compare a sufficient number of vendor prices for the specific product of interest.

Another problem in conventional approaches concerns the seamless integration of price comparison functionality as the user browses for products of interest. Some conventional price comparison approaches require users to redirect their browsers to the price comparison websites in order to carry out the comparison. Even worse, some conventional price comparison approaches additionally require users to perform a new product search using their proprietary portal interface, instead of the users preferred Internet search engine interface. In some cases, a user simply will not have sufficient knowledge to perform the product search through the proprietary portal, resulting in a very difficult time in finding the desired product price comparisons. Hence, when users use such conventional price comparison techniques they tend to suffer significant inconvenience, time consumption, and substantially limited product price comparison information.

Some known product advertisement (Ad) techniques “pop up” advertisements relevant to the content of the web pages that a user browses to on the Internet (examples include what is referred to as Adware, Spyware, and an ActiveX Control called Gator eWallet by GAIN Publishing). However, such techniques do not compare product prices, and suffer from pop up Ads that are not necessarily relevant to desired product, and, moreover, the user is often annoyed with and obstructed by the popping up of Ad windows at unexpected times. Moreover, Ads are typically not even limited to products and may be about anything that an advertiser decided to advertise.

Some travel oriented search engines are known to have plug-in interfaces with Internet web browsers. Such known product domain specific techniques will typically show a menu/navigation area (i.e., an explorer bar) in the web browser after the user visits a travel website and automatically enters the user's trip details to request a quote from the travel website visited. The explorer bar will typically ask the user if he or she wishes to compare against other prices, where upon requesting price comparisons, other travel sites are searched for the same itinerary and upon a successful search available prices from the other websites are shown within the explorer bar's body. Similar to the foregoing vendor limited approaches, such conventional product domain specific techniques typically only search affiliated vendor websites in the specific product domain. The prices are often searched for in real-time and not stored in advance. Another limitation these systems have is a lack of diversified product types to compare prices for. Such systems typically only compare prices for travel services.

In view of the foregoing, there is a need for improved techniques for the online price comparison of products. It would be desirable if the product vendors searched by the price comparison engine were not limited to only member product vendors. It would be further desirable if the improved price comparison techniques seamlessly integrate with the web user's natural web browsing experience while presenting thereto highly relevant product price comparisons.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary Graphical User Interface (GUI) toolbar implementation in accordance with an embodiment of the present invention;

FIG. 2 illustrates an exemplary architecture that is suitable to carry out the foregoing in accordance with an embodiment of the present invention;

FIG. 3 illustrates an exemplary flow chart of a product information web crawling method for the insertion of new products into the product centric vendor database, in accordance with an embodiment of the present invention;

FIG. 4 illustrates an exemplary flow chart of a product price web crawling method for the insertion of new vendors of preexisting products into the product centric vendor database, in accordance with an embodiment of the present invention;

FIG. 5 illustrates an exemplary flowchart of the interaction between the client-side agent and the server-side product server, in accordance with an embodiment of the present invention; and

FIG. 6 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of automatic product searching techniques are described.

In accordance with a method embodiment of the present invention, a method for product searching under a client/server environment is provided, which includes the steps of a client application monitoring web pages visited by a consumer, determining, by the client, if the visited web page is product oriented, generating a signature identifying the visited web page, sending the web page identifying signature from the client to a product server, and then searching a product centric database for a product corresponding to the web page identifying signature. If a corresponding product is found in the searching, the product server sends corresponding product purchasing related information to the client, and the client displays to the consumer at least part of the product purchasing related (e.g., product vendors and pricing) information. In some embodiments, the product searching method further including the step of extracting product identifying information from the visited web page, and additionally sending in the extracted product identifying information and additionally searching for a product corresponding to the extracted product identifying information.

However, if the visited web page is product oriented and not already represented in the product centric database yet other embodiments, update the database with the newly found product by further including the steps of extracting product purchasing related information from the visited web page, the client sending the extracted product purchasing related information to the product server, determining a suitable product category for a product in the product oriented web page, creating the product category in the product centric database, and finally storing both the product purchasing related information and the identifying signature into the product category in the product centric database such that the signature and product information correspondence is preserved for retrieval by a later product query.

Embodiments implementing a variety of sponsored vendor services are also provided, whereby additional product/vendor information is included into the product purchasing related information returned to the client.

Embodiments of the present invention may also include a method for creating a product centric database by at least performing the steps of having a first web crawler visiting a previously unvisited web page, generating a signature identifying the visited web page, determining if the visited web page is product oriented, determining a suitable product category for a product in the product oriented web page, extracting product related information from the visited web page that corresponds to the product, creating the product category in the product centric database, and then storing both the product related information and the identifying signature into the product category in the product centric database such that the signature and product information correspondence is preserved. Alternate embodiments further include a second web crawler that performs steps of using at least part of the extracted product related information to find prices corresponding to the product on other unvisited web pages, and storing both the corresponding product prices and the identifying signature into the product category in the product centric database such that the signature and product information correspondence is preserved.

Embodiments of the present invention are described that provide means and software product code that implements the forgoing methods.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

In one aspect of the present invention a product/service price comparison engine is provided which potentially searches the entire Internet, or web, for vendors of a particular product being searched for or viewed by a web user, while also allowing member product vendors to submit prices into a price comparison database. A member product vendor is typically a product vendor that has a business account (i.e., a member relationship) with an entity implementing an embodiment of the present invention. Embodiments of the present invention preferably automatically (e.g., without additional user action or prompting) generate product price comparisons for products a user is searching the web for and presents those price comparison results in an unobtrusive, natural manner. In particular, preferred embodiments are not implemented as what is commonly referred to as adware or spyware, and do not display obtrusive pop-ups, especially not Ads that are loosely determined to be similar to a web page the user is viewing. In a preferred embodiment of the present invention, all product price comparison information is displayed in a toolbar embedded in the user's web browser, which will display information relating to the specific product(s) that the user is searching for or viewing in a conventional web browser at any given time. In the preferred embodiment, this price comparison information is displayed automatically and does not require the user to enter any search query through the toolbar.

In some embodiments of the present invention, what are known as web crawlers are provided that attempt to associate every web page crawled to a particular product. By way of example, and not limitation, if a user navigates to a web page that the present web crawler associated a particular product to, a web application implementing an embodiment of the present invention might display all other page URLs that the present crawler(s) found containing the particular product.

In some alternative embodiments of the present invention, further provide a crawler behavior wherein if the crawler never reached a page that a user is currently viewing, the present toolbar application will search for product identification information on the web page and if found, a product server will use that product identification information to search a database for the product(s) being viewed. By way of example, and not limitation, the toolbar application might analyze a web page being viewed to see if there are product(s) being sold therein, where if the web page is indeed a product oriented web page, its web page content that describes the product(s) on the page and certain identifying signatures that describe the web page are sent to the server, thereby enabling the server to determine what product(s) is being looked at (as described in some detail below). If the particular product was found in the database, at least a portion, if not all, of the web pages related to that particular product and corresponding prices are displayed in the toolbar.

Because the gathering and displaying of accurate product related information is important to the user, embodiments of the present invention implement a multiplicity of specialized web crawlers that crawl the web searching for the wide range of product related information a typical consumer requires to make a purchasing decision. By way of example, and not limitation, one web crawler might collect information on products, and another crawler might find different vendor sites selling those products, and yet another crawler might search for vendor review/ratings, or any other pertinent product purchase related information. In general, crawlers of the present invention are configured with parsing algorithms that enable the parsing of each product oriented web site crawled to thereby extract relevant product information to populate a products database with pertinent information about the product(s) that each crawled web site is selling. For example, in some embodiments, if the product information crawler is parsing a book website, it might collect information such as ISBN, title of book, author, publisher, etc. In this way, another crawler looking to associate pages to a specific book may use the information in the products database to determine if another site is selling that particular book. The implementation details of visiting unknown webpages via web crawling for the present invention are well known to those skilled in the art.

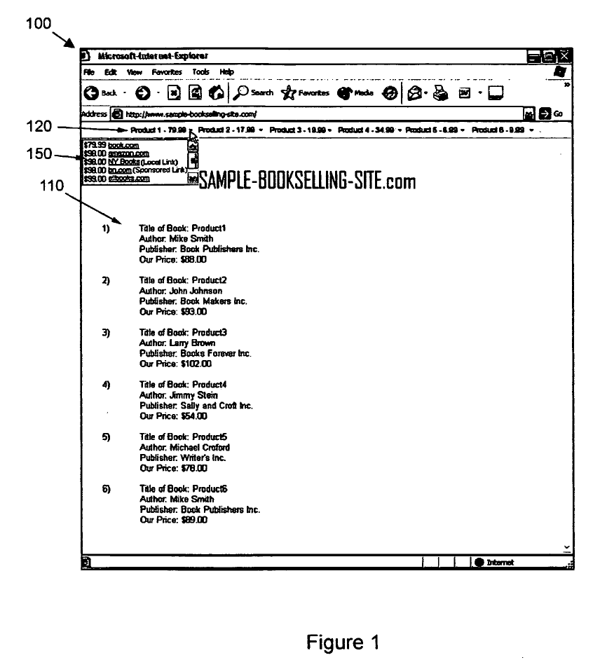

FIG. 1 illustrates an exemplary GUI toolbar implementation in accordance with an embodiment of the present invention. In the Figure, an otherwise conventional web browser 100 is shown viewing an exemplary website having the fictitious URL “www.sample-bookselling-site.com” to represent any product oriented website that may be viewed by a web browser. The product oriented web page contains product-oriented information 110, shown by way of example, and not limitation. In accordance with the teaching of the present invention, price comparison information 120 is displayed by a toolbar application, which price comparison information corresponds to the particular product(s) being displayed in product-oriented information 110. By way of further example, vendor websites where product-oriented information 110 was found are displayed in product vendor information 150 by the toolbar application. In example shown, for each exemplary “Product 1”, “Product 2”, and so forth displayed in product-oriented information 110, price comparison information 120 displays a corresponding lowest price found in the product database, if available. Of course, the example shown extends to any kind of website that contains product or service oriented information. Those skilled in the art will recognize a multiplicity of alternative and suitable ways, depending on the needs of the particular application, to appropriately configure a GUI for price comparison and vendor information instead of the exemplary way shown.

The present toolbar application may be created and installed into a user's web browser using known techniques. By way of example, and not limitation, the toolbar application may be a web browser plug-in, client (server) side JAVA applet, a pop up window, a stand alone application in communication with the web browser, etc, and installed by the user, the browser manufactures, or by any suitable known means.

In the embodiment shown in the Figure, once the present toolbar application is installed it continually generates and maintains the proper GUI for price comparison information 120 and product vendor information 150.

In one embodiment of the present invention, the toolbar application is in communication with a product database application, wherein as the viewer navigates to new product oriented web pages, the toolbar application transmits information to a Product Server connected to the Product Database. This information includes identifying product information found in the new web page and signature information about the webpage (such as the webpage's URL). Once the information is submitted to the Product Server, the Product Server searches the Product Database server for corresponding products/vendors and transmits any matching product price comparison information and product vendor information to the toolbar application for appropriate GUI display.

By way of a specific example, and not limitation, if a web user navigates conventional web browser 100 to common book selling web portal such as amazon.com and finds, for example, a web page with, say, displaying 6 different books for sale named “Product1,” “Product2,” through “Product6”. The present toolbar application might then send the ISBN number of each book and a set of unique signatures that represent the current web page to the product database server. Using this ISBN information, the product database server searches the present product database for web pages selling any of Products 1-6 and sends the toolbar application the found web URL links and the corresponding product prices, wherein, as shown by way of example in the Figure, the present toolbar application generates the required GUI to the user (e.g., displays price comparison information 120, and product vendor information 150).

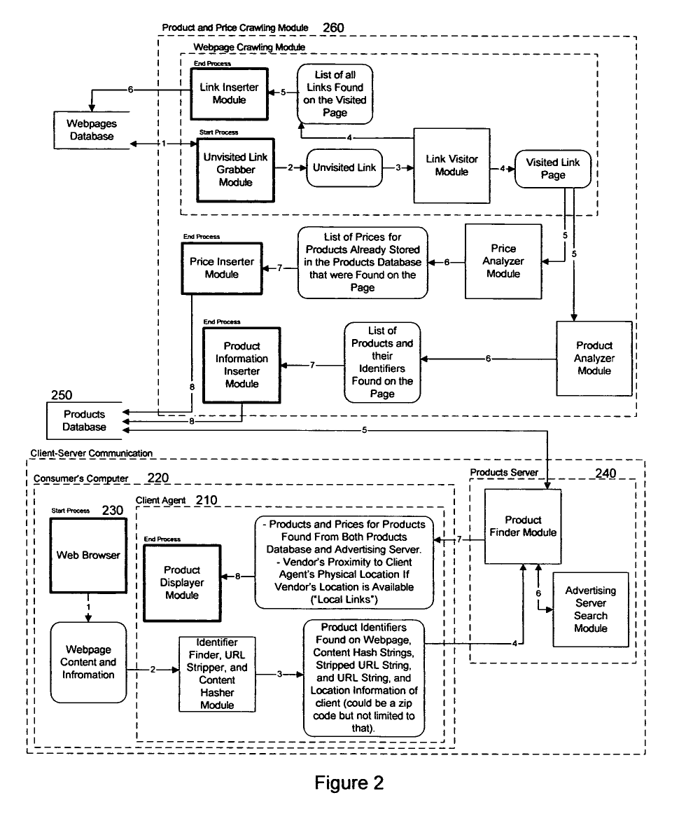

FIG. 2 illustrates an exemplary architecture that is suitable to carry out the foregoing in accordance with an embodiment of the present invention. As shown in the Figure, the present embodiment is implemented as a client/server architecture wherein a client-product detection agent 210 executes on the consumer's computer 220 and monitors the websites that the consumer navigates to using his or her web browser 230. If the web page that the consumer is viewing contains one or more products for sale, client-product detection agent 210 will send pertinent product oriented information based on the web page content and URL to a Products Server 240. The Product Server will use the client product oriented information to search a product database 250 and return to client-product detection agent 210 purchasing information comprising corresponding vendors and the prices that the vendors are selling the viewed products for. The purchasing information may be displayed to the user by way of a suitable purchasing information GUI; by way of example, and not limitation, product vendor information 150 or price comparison information 120 shown in FIG. 1. Vendors having a web presence and associated product-oriented information contained in their websites may be added into product database 250 by way of an automatic product and price web crawling module 260. As will be discussed in some detail in connection with the method thereof, comprised within product and price web crawling module 260 is a Web Page Crawling Module that handles the mechanics of crawling web pages. Through the use of a Web pages database, some of those mechanics include the tracking of previously visited web pages, harvesting of new URL links to visit, and the launching of analysis modules that harvest the desired decision making information (e.g., a Price Analyzer module and a Product Analyzer module that harvest pricing and product information, respectively) is properly compiled and inserted into product database 250.

However, vendors contained within product database 250 are not limited to online vendor, but may include vendors with no web presence by way of a manual product/price submission mechanism that does not rely on the automatic web crawler price searching mechanism. Vendors that do have a web presence may have a link to their product page included within the product search results. Vendors with no web presence may have a link that appropriately redirects the consumer's web browser, or otherwise proved the consumer with their contact information; for example, by way of a popping up a new window that will show phone number and address information for that vendor.

Those skilled in the art will readily recognize that client-product detection agent 210 as described may be implemented in a multiplicity of suitable ways in accordance with the teaching of the present invention. For example, in some embodiments, client-product detection agent 210 may be implemented as a separate GUI window, or in other embodiments as an integrated toolbar of some executing program (for example: an explorer bar, explorer toolbar, or taskbar). In some applications, it may be desirable to enable the user to easily toggle on and off the GUI display of the present invention, which is especially useful when the user is not interested in shopping.

The operation of client-product detection agent 210 is preferably made transparent to the user by automatically sending information to Product Server 240 when the user reaches a web page containing product oriented information; in some embodiments it will send information even if the GUI display is toggled off. In this way, the user is not burdened with any product searching details or knowing any ad hock searching parameters. Moreover, as client-product detection agent 210 directly displays purchasing information in its purchasing information GUI, unlike conventional approaches, the user's need to redirect the browser to another page or popup new windows in order to view price comparison information is substantially eliminated.

The foregoing system modules of FIG. 2 will now be described in some detail. One aspect of the present invention is related to what is commonly referred to as datamining. In the respect, unlike conventional product datamining approaches, the present datamining system collects product and price information that not only potentially spans the entire web, but the present datamining system is further capable of categorizing product pages according to product type. The product categorizing aspect of the present invention may be achieved by a multiplicity of suitable methods. Some of these product categorizing methods presented herein seek to discover new product oriented web pages, then provide a signature that will uniquely represent each product oriented web page found, and then extract any product oriented and pricing information found to build a product centric vendor database. Thus, the compiled product centric vendor database of the present invention substantially overcomes the conventional problem of having to compare prices of specific product across various web pages. Hence, instead of comparing different kinds of products all at once, as is done by conventional approaches, vendors of same product may be simultaneously compared.

To automatically build the product centric vendor database automatic web crawler(s) are preferably employed. Those skilled in the art may recognize known web crawling techniques that may be suitably adapted according to the teachings of the present invention. What follows is one suitable embodiment of a method for web crawling and is set forth by way of example and not limitation. A goal of the present web crawler being described is to discover unvisited web pages that contain product oriented information. A web crawler generally requires some form of initialization, which may be manual or automatic. In the manual approach, the web crawler is manually provided with several “seed” web pages for it to start from, which are visited and harvested for all the links (i.e., universal resource locater, or URL) that appear on the corresponding web pages. The newly discovered links are marked as “unvisited links” and stored into a link database. The crawler will then visit at least a portion of the “unvisited links” and repeats the “unvisited link” harvesting process, thereby continually building a growing database of unvisited web pages. Every link that the crawler does visit is recorded as a “visited link”. Using this method, the crawler will eventually visit a relatively large number of web pages in a relatively small amount of time as compared to a manual human discovery process. In a preferred embodiment of the present invention, the web crawler(s) reside on the server-side (e.g., in the product database server); however, alternative embodiments are contemplated which may execute the web crawler(s), at least in part, on the client side (e.g., in the client-product detection agent), whereby the automatically harvested information will additionally be transmitted back to the server-side (along with any manually discovered product oriented information) towards building the product centric vendor database.

To efficiently identify a previously visited web page marked as a “visited link”, a web page signature method is used. In one embodiment of the web page signature method, once the crawler arrives to a web page, it will store useful signatures that will help identify the web page if it is ever revisited by the web crawler(s) or a client-side user/agent that manually browses the web. A conventional approach to identifying a web page is simply by recording its URL; however, URLs are often insufficient and unreliable at least because they often contain extraneous contextual information (e.g., a session identification and user preferences). Instead, one embodiment of the present web page signature method employs the following data processing process to sufficiently identify a web page uniquely.

The least complex technique to identify a web page is by way of its URL, especially when it does not include embedded dynamic information. In the present embodiment, upon landing on a web page, the web crawler first searches the link database for the corresponding URL. If the URL is not found in the link database, a URL cleaning, or stripping, operation is performed to extract the static and usable part of the URL for archival purposes. In one embodiment, extraneous URL information is removed to form what is herein referred to as a “Dynamic Stripped URL String” (explained in some detail below), which is used to again search the link database for a corresponding URL.

Those skilled in the art will ready recognize a multiplicity of suitable techniques to remove extraneous URL information. By way of example, and not limitation, a method suitable to generate a cleaned, dynamic stripped URL string according to an embodiment of the present invention will now be described. Typically, if any cookie information is stored within the original URL string, it is that it relates to a session ID or some other dynamic piece that may change every time that a different computer visits the page. In this case, the present URL stripping method marks the cookie information stored within the URL as described in the context of the following exemplary URL: http://www.someplace.com/directory1/123-3948-22949? productNumber=5&sessionID=123-3948-22949. In this example URL, a session ID is stored twice within the URL: once in the path and once in the query string. After examining the cookies in the header, if one of the cookies contains the name and value “sessionID=123-3948-22949” then the present crawler replaces the cookie value in the URL with the cookie name enclosed in “<” and “>”, or some other form that will mark where the cookies were. In this example, the stripped URL string will look like this: http://www.someplace.com/directory1/<sessionID>?productNumber=5&sessionID=<sessionID>. In this embodiment, all URLs and Dynamic Stripped URL Strings stored in the link database will be stored with their query string parameters sorted by name. This is done to ensure that if ever desired to compare two URLs, query string order will not affect a positive match. For example, the URL http://www.someplace.com/index.html?c=1&a=2&b=3 will be stored as: http://www.someplace.com/index.html?a=2&b=3&c=1. If the “Dynamic Stripped URL String” is not found when we search the database, or finds more than one of the same “Dynamic Stripped URL String”, the crawler then tries searching for what is herein referred to as “Content Hash Strings”, which is explained in some detail next.

Content Hash Strings are created by implementing certain “Content Hashing Rules”, which are typically employed when stripping out cookie information from the URL is inadequate to uniquely identify a web page. A URL may store cookie information that is valuable in uniquely identifying the URL, but is stripped out by the foregoing “Dynamic Stripped URL String” method. A URL may also contain dynamic values that are not stored in the cookie header. It is at least in these situations that Content Hashing Rules are helpful provide an extra check before concluding that a URL is not stored in the database. In one embodiment of the present Content Hashing method, a set of rules are executed upon the content of the web page, wherein each rule will put together a string that will be hashed to create a relatively short signature of the string. Some of the rules may be, by way of example, and not limitation: “create a string out of every word that appears more than 10 times in the page”, or “create a string from every word that starts with the letter b,” and so forth. After running a few of these rules, the hashes are stored in the database and can later on be compared against a set of hash strings sent over by the client-product detection agent.

The number of rules to run is typically an empirical determination made where a sufficient number of rules is achieved when the rules do not return strings that are the same when run on different web pages. More rules are sometimes required to accommodate web pages whose content change often (e.g., a web page may show user comments that are constantly being added, load different advertisements, or even show the time of day). Too few rules will increase the chance of having a rule set that will be effected by the changed data (e.g., user comments, advertisements . . . ) that preferable should not effect the signature of a web page. Those skilled in the art will readily configure and implement an optimal hash rule set without undue experimentation. Moreover, a multiplicity of alternative and suitable methods to generate a signature to uniquely identify a web page will be likewise readily apparent to those skilled in the art.

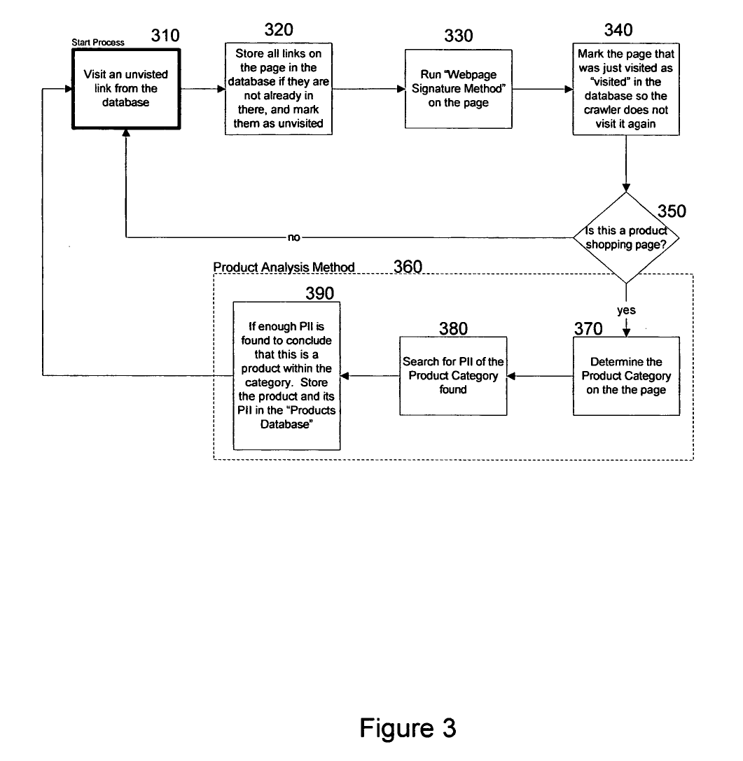

FIG. 3 illustrates an exemplary flow chart of a product information web crawling method for the insertion of new products into the product centric vendor database, in accordance with an embodiment of the present invention. As shown in the Figure, the foregoing aspects are sequenced into a web crawling, analysis, and harvesting process. The present exemplary process begins at Step 310 the crawler visits an unvisited URL from the link database. At Step 320 the crawler store all links on the page in the link database, unless they already exist, and marks them as unvisited. The Web page Signature Method is executed at Step 330. The resulting web page signature and a marking of ‘visited’ are entered into the link database at Step 340 so that the crawler does not revisit the same web page.

At Step 350, it is determined if the web page being evaluated is selling a product. This may be achieved by any known and suitable techniques. In one embodiment, determining if the web page being evaluated is a product page is achieved by searching for comment text associated with product selling; by way of example, and not limitation, such text may include: “$”, “shopping cart”, “buy”, etc, whereby if a sufficient amount of these product selling words are found, the web page being evaluated is presumed to be a product page. If at Step 350 it is determined that the new web page is a product page, then a product analysis method according to an embodiment of the present invention is invoked at Step 360 to locate product-oriented information on the new, unvisited web page. In one aspect of the present Product Analysis products are searched for by looking for “Product Identifying Information” (PII) on the web page being analyzed. A list of product categories and the PII types associated with each product category are manually populated in a product database. For example, the “Books” product category will have the following PII types: ISBN, Author, Title, Publisher, etc. At Step 370, the crawler will determine the product category of the new web page and seek to create a corresponding product entry and add products under the appropriate categories stored in the product database by searching at Step 380 for the PII on new web pages it visits. If sufficient PII is found to justify storing a new product in the database, the product will be stored at Step 390 along with the PII of that particular product. By way of example and not limitation, if the crawler visits a web page with the book “Romeo and Juliet”, and was able to parse out the Title (Romeo and Juliet), ISBN number (0486275574), and Author (William Shakespeare), then the crawler would add the book's PII to the “product centric database” (PD) if it doesn't already exist therein. The present product analysis method provides a first layer of crawling according to an aspect of the present invention. If Step 350 fails, then a new unvisited website is visited to restart the present process at Step 310.

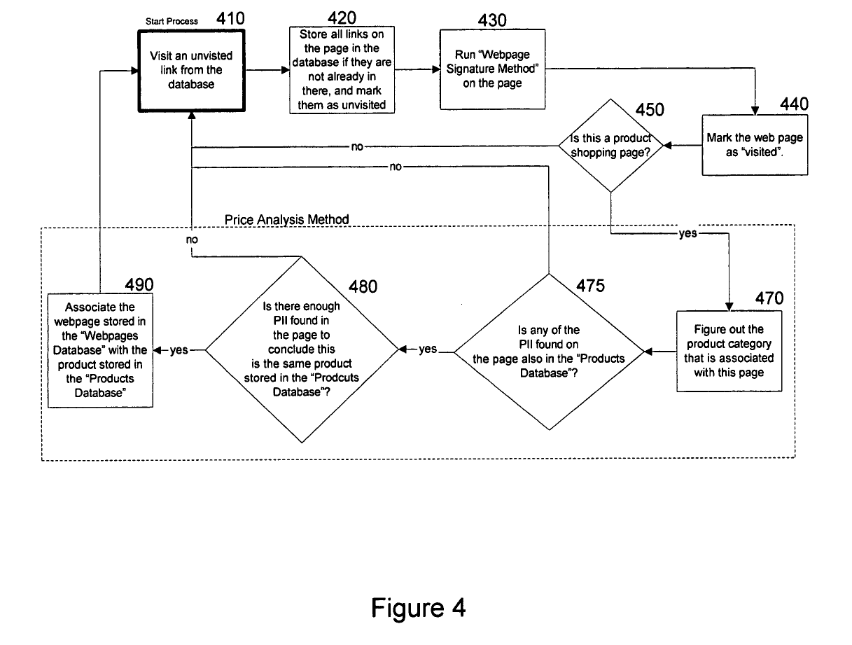

Once the PD is filled with product information, another layer of crawling for prices begins. Price crawling will look for PII of products that already exist in the PD. If enough PII is found on the page to conclude that the product on the page is one of the products stored in the PD, then the page is stored in a “Webpages Database” (WD) with the data attained from the Webpage Signature Method, and is marked as associated with the particular product found in the PD. FIG. 4 illustrates an exemplary flow chart of a product price web crawling method for the insertion of new vendors of preexisting products into the product centric vendor database, in accordance with an embodiment of the present invention. The price analysis method shown illustrates an exemplary price crawling process for entering preexisting product pricing information into the Products Database. The present process starts in a manner similar to Steps 310 to 350 of FIG. 3, where if at Step 450 it is determined that the new web page is a product page, then a vendor price analysis method according to an embodiment of the present invention is invoked at Steps 470-490 to locate product pricing information on the new, unvisited web page and insert the new vendor and its price for the product into the product centric vendor database if a preexisting product in the database is found in the new web page. In particular, At Step 470, a product category is determined. At Step 475, it is determined whether there any of the PII found on the new web page matches any existing product(s) in the product centric vendor database. It should be appreciated that the PII for the existing product(s) may have been harvested by another web crawler as described in FIG. 3. Continuing the description of FIG. 4, if, at Step 480, there is sufficient PII found in the web page to conclude this is the same product stored in the product centric vendor database, then, at Step 490, the associated website link information (i.e., the “vendor”) is added to the product centric vendor database as a vendor of the corresponding product(s). If either of Steps 475 or 480 fail, then a new unvisited website is visited to restart the present process at Step 410.

In a preferred embodiment, all web pages associated with products and prices will be revisited on a regular basis to insert updated information to the product centric vendor database if the content of the web page changes in a manner that effects the stored data. For example, a vendor may change the price of an item, or no longer sell the product for some reason. This needs to be updated in the database.

In accordance with a user aided crawling aspect of the present invention, in one embodiment, if a user with the client-product detection agent installed on his or her computer visits a web page that is not in the links database, it will be added to that database as an “unvisited” page, which will cause the automatic web crawlers to later visit the web page. In this way, the user guided web searching efforts contribute to the size and quality of the product centric vendor database.

In accordance with an alternative method of adding vendors to the product centric vendor database, a Manual Product and Price Submissions method is provided. In one embodiment of the manual submission method, vendors may associate themselves to products by submitting their price information for products they are selling. This price information will be associated with a specific product in the PD. If the product they are selling does not exist in the PD, they can request to add it to the PD. The product addition request will need to be granted by one of the administrators of the present invention. The combination of automatic web crawling, client guided web searching, and manual submissions tends to provide a more complete collection of vendors selling specific products while also maintaining a higher level of accuracy as compared to conventional techniques.

Those skilled in the art are able to readily configure embodiments of the client-side of the present invention into commonly used web accessing software applications, thereby providing a means for automatically displaying vendor and pricing information generated from the server-side aspect of the presenting that corresponds with a product(s) that is being sold on the web page being viewed by the user.

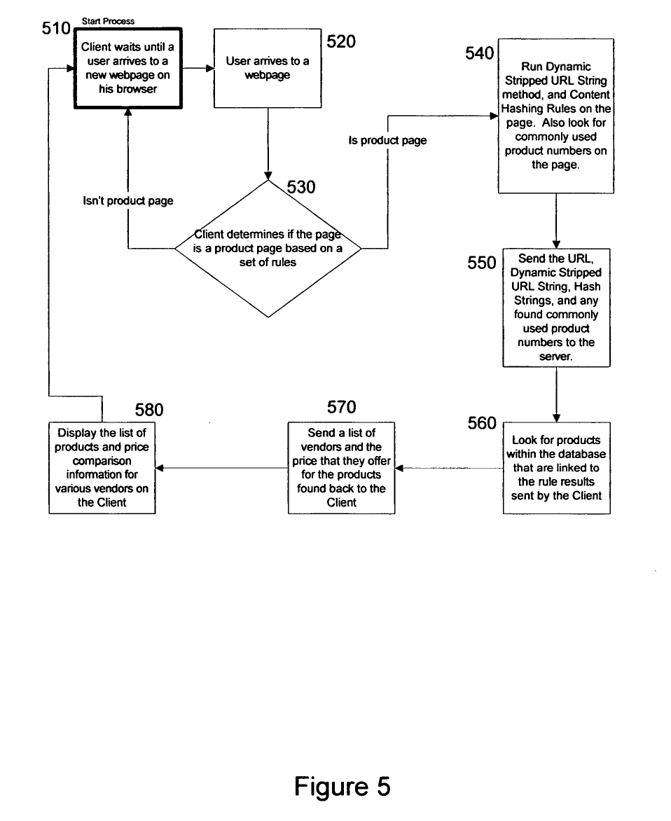

FIG. 5 illustrates an exemplary flowchart of the interaction between the client-side agent and the server-side product server, in accordance with an embodiment of the present invention. In the embodiment shown, the process begins at Step 510, where the client-product detection agent (client agent) watches every web page that the user browses to on his or her web browser and waits for a new page to be visited. Upon arriving at a new web page at Step 520, the client agent, according to the present embodiment, will, at Step 530, attempt to determine if the web page being viewed is selling a product by any known and suitable techniques. In one embodiment, determining if the web page being viewed is a product page is achieved by searching for comment text associated with product selling; by way of example, and not limitation, such text may include: “$”, “shopping cart”, “buy”, etc, whereby if a sufficient amount of these product selling words are found, the web page being viewed is presumed to be a product page and then, at Step 540, the web page's Dynamic Stripped URL String and Content Hash Rules (as described in some detail above) are calculated. The present client agent will also search for commonly used product identifying information including, but not limited to, numbers such as “UPC”, “ISBN”, and “SKU” in the page. At Step 550, the client agent sends the web page's URL, “Dynamic Stripped URL String”, “Content Hash Strings”, and any product identifying information to the Product Server.

Continuing the description of the present embodiment, after the Product Server receives the information from the client agent, it determines, at Step 560, if any web crawlers have visited the web page(s) viewed by the end user before by initially searching for its URL in the database. If the URL is not found, it searches for the “Dynamic Stripped URL String”. If several results were returned, the server looks for the result with the most content hash string matches. If no results are found after the “Dynamic Stripped URL String query”, then it will search for any page that matches the hostname of the URL and at least a certain number of content hash strings. At Step 570, if the Product Server finds a web page match in the product centric vendor database after using a multiplicity of suitable search options, it will send all pricing and vendor information of the product(s) associated with that web page to the client-product detection agent. If it is the case that the web crawlers have not visited the web page before, then the product identification information (e.g., product ID numbers) is searched for in the database product centric vendor database. In one embodiment, if each number in the product identification information matches only one product's ID numbers in the database, the Product Server sends pricing and vendor information for the product(s) associated with that web page to the client agent for display thereby to the end user at Step 580.

Those skilled in the art will readily recognize that in any of the forgoing methods described, a multiplicity of alternative, and suitable steps may be inserted, removed, reordered or otherwise modified to best suit the needs of the particular application.

Alternative embodiments of the present invention may include a multiplicity of vendor support modules and methods that provide additional functionality for vendors who may be interested in using implementations of the present invention. Some vendor support services in accordance with alternative embodiments of the present invention include, but are not limited to the following.

One embodiment of an alternative vendor support services sponsors vendors through a multiplicity of advertising services. For example, if a vendor chooses to advertise a product he or she is selling on an advertising service provider (such as Overture, for example). The Product Server of the present system will comprise an Advertising Server, which among other functions described below, searches the advertising service provider for Ads that deal with a specific product that the present Product Server returned results for. The Product Server will be searched with product specific information, which may include product numbers and full product name. If any of the vendors returned by the present system's Product Server are found in the result set from the advertising service search, then the link to their product will be replaced with the Product/Advertising server's link. In addition to the link replacement, the client agent may display that vendor's name as a “sponsored vendor.”

In another embodiment of an alternative vendor support services sponsored vendors may be included by way of directly paying the owner/operator of embodiments of the present invention. That is, if a vendor chooses to pay this system's owner's to become a “sponsored vendor”, any results returned to the client by that vendor will be displayed as “sponsored vendors” within the Client.

Yet another embodiment of an alternative vendor support services is geared towards local vendors. By way of example, and not limitation, a vendor can choose to provide his address to the owner/operator of embodiments of the present invention to become what is herein referred to as “Local Vendor Enabled”. For example, each client agent will ask its user to provide a postal zip code when it is executed for the first time after installation. The client agent will send the user's postal zip code to the server with every automated search request. In some embodiments, if a vendor about to be returned by the Product Server is a “Local Vendor Enabled”, the server can use postal zip code Longitude and Latitude coordinates, for example, to approximate the distance between the vendor and the client agent. If the distance is smaller than a certain threshold, the vendor result is sent as a “Local Vendor” result. The client agent may display these results as “Local Vendor” results. Those skilled in the art will recognize a multiplicity of alternative and known ways to best implement a “local vendor” service depending on the needs of the particular application and in accordance with the teaching of the present invention.

In yet another embodiment of an alternative vendor support services is geared towards product assistance. By way of example, and not limitation, a vendor may choose to become what is herein referred to as “Product Assistance Enabled”, wherein during the hours that the vendor's business is open, “Product Assistance Enabled” vendors will provide a means of being Instant Messaged by users interested in sales assistance, such as asking them questions about a product being displayed in the client agent results.

In some embodiments of an alternative vendor support services vendors and individuals may submit prices for “used” (i.e., pre-owned) items, which would be accordingly marked; by way of example, and not limitation, pre-owned items might be marked as “used” in the result set of the toolbar.

It will be apparent that the attendant aspects of the present invention as described in the forgoing provide for an automated search technique have improved accuracy of and richness of information that is of value to a wide diversity of end users/consumers (and vendors) who would be interested in installing the present client agent on their computers.

Some of the attendant user value aspects of the present invention include, but are not limited to, automatically finding a better deal on the Internet without requiring special know how, time consuming meandering through the Internet, being limited to member vendors. Some users may simply enjoy seeing other vendor prices as he or she browses the Internet for product. From a vendor point of view, vendors will tend to be interested in the extra service provided by the foregoing vendor support aspects of the present invention at least because of the increased marketing exposure and potential product sales.

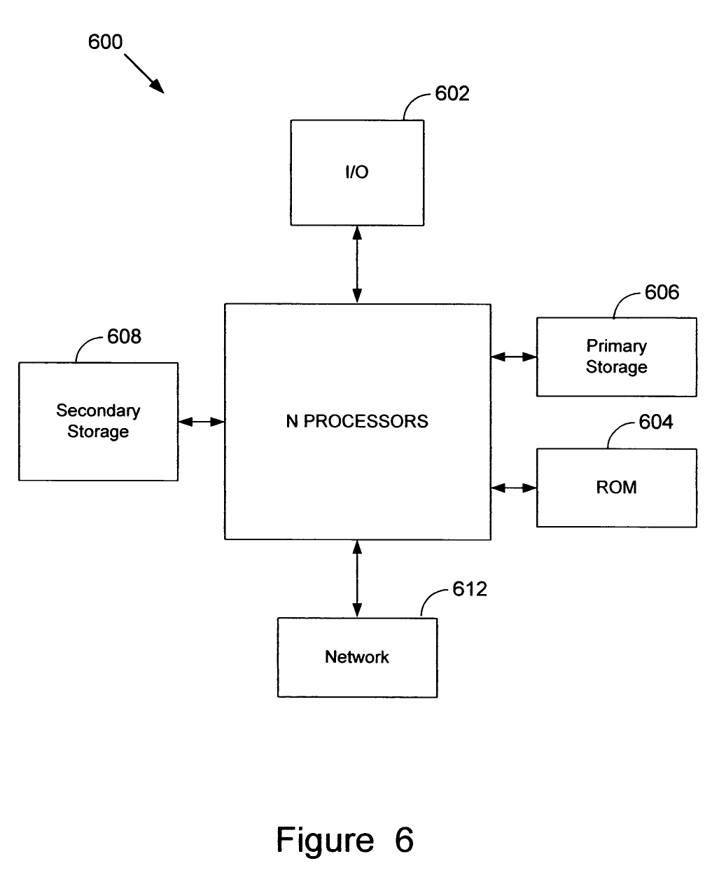

FIG. 6 illustrates a typical computer system that, when appropriately configured or designed, can serve as a computer system in which the invention may be embodied. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers and microprocessors such as programmable devices (e.g., CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or Internet network using an external connection as shown generally at 612. With such a connection, it is contemplated that the CPU might receive information from the network, or might output information to the network in the course of performing the method steps described herein.

Having fully described at least one embodiment of the present invention, other equivalent or alternative methods and systems for automatic product vendor searching according to the present invention will be apparent to those skilled in the art. The invention has been described above by way of illustration, and the specific embodiments disclosed are not intended to limit the invention to the particular forms disclosed. For example, the particular implementation described in the foregoing were directed to price harvesting and display implementations; however, similar techniques are contemplated to apply to a multiplicity of alternative embodiments of the present invention, which may be readily adapted to harvest and present to the user additional forms of desirable product related information beyond price. That is, when searching a web page for product identification information in addition to finding and storing the vendor's price for the product, the web crawler(s) may also harvest other valuable information to the user's decision-making process. By way of example, and not limitation, information such as product reviews by professionals and product consumers may be found, stored, and displayed in a manner very similar to the foregoing methods and systems described for product prices. Such alternative implementations of the present invention and their equivalents are contemplated as within the scope of the present invention. The invention is thus to cover all modifications, equivalents, and alternatives falling within the spirit and scope of the following claims.

What is claimed is:

1. In a client/server environment, a method for product searching comprising the steps of:
a) a client receiving a visited web page;
b) determining, by the client, if the visited web page is product oriented;
c) generating a signature identifying the visited web page;
d) sending said web page identifying signature from said client to a product server;
e) searching a product centric database for a product corresponding to said web page identifying signature;
f) if a corresponding product is found in the searching, said product server sending corresponding product purchasing related information to said client; and
g) said client displaying to a consumer at least part of said product purchasing related information.

2. The product searching method of claim 1, further comprising the step of extracting product identifying information from the visited web page; and wherein the sending in d) further comprises sending said extracted product identifying information and the searching in e) further comprises searching for a product corresponding to said extracted product identifying information.

3. The product searching method of claim 1, wherein the determining in d) comprises the step of searching for common text associated with product selling.

4. The product searching method of claim 1, further comprising the steps of, if the visited web page is product oriented and not already represented in said product centric database:
extracting product purchasing related information from the visited web page;
the client sending said extracted product purchasing related information to said product server;
determining a suitable product category for a product in the product oriented web page; and
storing both said product purchasing related information and said identifying signature into said product category in said product centric database such that said signature and product information correspondence is preserved.

5. The product searching method of claim 1 wherein said product purchasing related information comprises product descriptive or product identifying information.

6. The product searching method of claim 1 wherein said product purchasing related information comprises product rating information.

7. The product searching method of claim 1 wherein said product purchasing related information comprises product vendor and product pricing information.

8. The product searching method of claim 1 wherein the receiving in a) is by a software client application executing on the client-side and is in operable communication with a web browser the consumer is using to navigate to the visited web page.

9. The product searching method of claim 1, wherein the signature generating is at least in part based on URL stripping and web page content hashing.

10. The product searching method of claim 1, further comprising the step of including sponsored vendor links in the product purchasing related information.

11. The product searching method of claim 1, further comprising the step of including in the product purchasing related information the distance of at least one vendor to the consumer.

12. The product searching method of claim 1, further comprising the step of the client providing the consumer an instant messaging capability to a vendor.

13. The product searching method of claim 1, wherein the displaying to the consumer is by displaying at least part of said product purchasing information in a toolbar embedded in a web browser, which web browser is used to visit the visited web page.

14. The product searching method of claim 1, wherein the product purchasing information comprises vendor URL links and corresponding product prices for the product.

15. The product searching method of claim 1, wherein all the Steps therein occur automatically, without directly prompting the consumer for information.

16. The product searching method of claim 1, further comprising the Step of including in said product purchasing related information sent to the client at least one vendor of the product that is geographically near the consumer.

17. The product searching method of claim 1, further comprising the Steps of:
searching an advertising service provider for advertisements corresponding to a vendor included in said product purchasing related information sent to the client; and
setting the URL for the vendor link in said product purchasing related information to that of the advertisement found in the advertisement searching.

18. A method for creating a product centric database comprising the steps of, a first web crawler:
a) visiting a previously unvisited web page;
b) generating a signature identifying the visited web page;
c) determining if the visited web page is product oriented;
d) determining a suitable product category for a product in the product oriented web page;
e) extracting product related information that relates to the product category found in d) from the visited web page that corresponds to the product;
f) creating a product entry in said product centric database;
g) storing both said product related information and said identifying signature into said product entry in said product centric database such that the signature and product information correspondence is preserved.

19. The product centric database creating method of claim 18, wherein the signature generating is at least in part based on URL stripping and web page content hashing.

20. The product centric database creating method of claim 18, further comprising the steps of, a second web crawler:
using at least part of said extracted product related information to find prices corresponding to the product on other unvisited web pages; and
storing both said corresponding product prices and said identifying signature into said product entry in said product centric database such that the signature and product information correspondence is preserved.

21. The product centric database creating method of claim 20 wherein the visited web pages are periodically revisited to keep the information in the product centric database up to date.

22. The product centric database creating method of claim 18, further comprising the step of vendors directly submitting product prices into in said product centric database.

23. In a client/server environment, an apparatus for product searching comprising:
a) means for a client to receive a visited web page;
b) means for determining, by the client, if the visited web page is product oriented;
c) means for generating a signature identifying the visited web page;
d) means for sending said web page identifying signature from said client to a product server;
e) means for searching a product centric database for a corresponding product;
f) if a corresponding product is found by said searching means, means for said product server sending corresponding product purchasing related information to said client; and
g) means for said client displaying to a consumer at least part of said product purchasing information.

24. The product searching apparatus of claim 23, further comprising:
means for extracting product identifying information from the visited web page; and
means for sending said extracted product identifying information to said product server, wherein said searching means also searches for a product corresponding to said extracted product identifying information.

25. The product searching apparatus of claim 23, further comprising, if the visited web page is product oriented and not already represented in said product centric database:
means for extracting product purchasing related information from the visited web page;
means for the client to send said extracted product purchasing related information to said product server;
means for determining a suitable product category for a product in the product oriented web page;
means for creating a product entry in said product centric database; and
means for storing both said product purchasing related information and said identifying signature into said product entry in said product centric database such that said signature and product information correspondence is preserved.

26. The product searching apparatus of claim 23, further comprising means for including in the product purchasing related information the distance of at least one vendor to the consumer when a vendor location available.

27. The product searching apparatus of claim 23, further comprising means for the client to provide the consumer an instant messaging capability to a vendor.

28. The product searching apparatus of claim 23, further comprising means for including sponsored vendor links in the product purchasing related information.

29. A computer program product for product searching comprising:
a) computer code for a client to receive a visited web page;
b) computer code for determining, by the client, if the visited web page is product oriented;
c) computer code for generating a signature identifying the visited web page;
d) computer code for sending said web page identifying signature from said client to a product server;
e) computer code for searching a product centric database for a corresponding product;
f) if a corresponding product is found by said searching means, computer code for said product server sending corresponding product purchasing related information to said client; and
g) computer code for said client displaying to a consumer at least part of said product purchasing information.

30. The computer program product of claim 29, further comprising:
computer code for extracting product identifying information from the visited web page;
computer code for sending said extracted product identifying information to said product server, wherein said searching means also searches for a product corresponding to said extracted product identifying information.

31. The computer program product of claim 29, further comprising, if the visited web page is product oriented and not already represented in said product centric database:
computer code for extracting product purchasing related information from the visited web page;
computer code for the client to send said extracted product purchasing related information to said product server;
computer code for determining a suitable product category for a product in the product oriented web page;
computer code for creating a product entry in said product centric database; and
computer code for storing both said product purchasing related information and said identifying signature into said product entry in said product centric database such that said signature and product information correspondence is preserved.

32. The computer program product of claim 29, further comprising computer code for including in the product purchasing related information the distance of at least one vendor to the consumer when a vendor location available in database.

33. The computer program product of claim 29, further comprising computer code for the client to provide the consumer an instant messaging capability to a vendor.

34. The computer program product of claim 29, further comprising computer code for including sponsored vendor links in the product purchasing related information.

35. The computer program product of claim 29 wherein the computer-readable medium is one selected from the group consisting of a data signal embodied in a carrier wave, a CD-ROM, a hard disk, a floppy disk, a tape drive, and semiconductor memory.
